(19) United States
(12) Patent Application Publication
(10) Pub. No.: US 2026/0369647 A1
(43) Pub. Date: Nov. 19, 2026

(54) INTERCONNECTOR FOR A STACK OF SOEC/SOFC-TYPE SOLID OXIDE CELLS HAVING A PERFORATED CONTACT LAYER

(71) Applicant: COMMISSARIAT A L'ENERGIE ATOMIQUE ET AUX ENERGIES ALTERNATIVES, Paris (FR)

(72) Inventors: Karl VULLIEZ, Grenoble (FR); Manon ELIE, Grenoble (FR); Géraldine PALCOUX, Grenoble (FR); Stéphane DI IORO, Grenoble (FR)

(73) Assignee: COMMISSARIAT A L'ENERGIE ATOMIQUE ET AUX ENERGIES ALTERNATIVES, Paris (FR)

(21) Appl. No.: 19/140,605

(22) PCT Filed: Dec. 20, 2023
(86) PCT No.: PCT/FR2023/052075

§ 371 Date: Jul. 15, 2025

(30) Foreign Application Priority Data
Dec. 20, 2022 (FR) FR2213927

(51) Int. Cl. H01M 8/2432

(52) U.S. Cl. CPC H01M 8/2432

(57) ABSTRACT

The main subject matter of the invention is an interconnector (5) for a stack of SOEC/SOFC type solid oxide cells, intended to be arranged between two adjacent electrochemical cells, formed by assembling at least three elongated plates (22, 23) in first and second axes of symmetry, the central plate (22) comprising slots (71, 72, 73, 74), each slot comprising tabs spaced apart from one another to form a comb and slits, characterized in that at least one of the first end plate and the second end plate (23) is covered in the central portion with a contact layer (90), the surface area of which is greater than that of the central portion of the central plate, comprising at least one elongated contact slot (92) along a length (L_{c}) greater than the length (Lₚ) of the central portion and formed in superposition with at least one slot (71, 72, 73, 74) of the central plate (22).

### TECHNICAL FIELD

The present invention relates to the general field of High Temperature Electrolysis (HTE), in particular High Temperature Steam Electrolysis (HTSE), carbon dioxide (CO₂) electrolysis, and even high temperature co-electrolysis of steam and carbon dioxide (CO₂).

More specifically, the invention relates to the field of high-temperature Solid Oxide Electrolysis Cells, commonly referred to as SOECs.

It also relates to the field of high-temperature Solid Oxide Fuel Cells, commonly referred to as SOFCs.

Thus, more generally, the invention relates to the field of solid oxide cell stacks of the SOEC/SOFC type operating at high temperature.

More specifically, the invention relates to an interconnector for a stack of SOEC/SOFC type solid oxide cells comprising at least one perforated contact layer, and a stack of SOEC/SOFC type solid oxide cells comprising a plurality of such interconnectors.

### PRIOR ART

In the context of a high-temperature solid oxide electrolysis cell (SOEC), it involves converting steam (H₂O) into dihydrogen (H₂) or other fuels such as methane (CH₄), natural gas, biogas, and dioxygen (O₂), by means of an electric current and within the same electrochemical device, and/or converting carbon dioxide (CO₂) into carbon monoxide (CO) and dioxygen (O₂). In the context of a high-temperature solid oxide fuel cell (SOFC), the operation is reversed to produce electric current and heat by being supplied with dihydrogen (H₂) and dioxygen (O₂), typically in air and natural gas, namely by methane (CH₄). For simplicity, the following description favors the operation of a high-temperature solid oxide electrolysis cell (SOEC) performing the electrolysis of steam. However, this operation is applicable to the electrolysis of carbon dioxide (CO₂), and even to the high-temperature co-electrolysis of steam (HTE) with carbon dioxide (CO₂). In addition, this operation is transposable in the case of a high-temperature solid oxide fuel cell (SOFC).

To carry out water electrolysis, it is advantageous to carry it out at high temperature, typically between 600 and 1000 °C, because it is more advantageous to electrolyze steam than liquid water and because a portion of the energy required for the reaction can be supplied by heat, which is less expensive than electricity.

To implement high temperature steam electrolysis (HTSE), an SOEC type high-temperature solid oxide electrolysis cell consists of a stack of unit cells each comprising a solid oxide electrolysis cell, or electrochemical cell, consisting of three anode/electrolyte/cathode layers superposed on one another, and interconnection plates often made of metal alloys, also known as bipolar plates or interconnectors. Each electrochemical cell is clamped between two interconnection plates. An SOEC type high-temperature solid oxide electrolysis cell is then an alternating stack of electrochemical cells and interconnectors. An SOFC type high-temperature solid oxide fuel cell is composed of the same type of stack of unit cells. As this high-temperature technology is reversible, the same stack can operate in electrolysis mode and produce hydrogen and oxygen from water and electricity, or in fuel cell mode and produce electricity from hydrogen and oxygen.

Each electrochemical cell corresponds to an electrolyte/electrode assembly, which is typically a ceramic multilayer assembly wherein the electrolyte is formed by a central ion conductive layer, this layer being solid, dense and impervious, and clamped between the two porous layers forming the electrodes. It should be noted that additional layers can exist, but are only used to enhance one or more of the layers already described.

Electrical and fluidic interconnection devices are electron conductors which ensure, from an electrical point of view, the connection of each unit electrochemical cell in the stack of unit cells, guaranteeing electrical contact between one face and the cathode of one cell and between the other face and the anode of the following cell, and from a fluidic point of view, the supply of reagents and discharge of products for each of the cells. The interconnectors thus fulfill the functions of supplying and collecting electric current and delimit gas flow compartments, for distribution and/or collection.

More specifically, the main function of the interconnectors is that of ensuring the flow of electric current but also the flow of gases in the vicinity of each cell (i.e.: injected steam, hydrogen and oxygen extracted for HTE electrolysis; air and fuel including injected hydrogen and extracted steam for an SOFC cell), and of separating the anode and cathode compartments of two adjacent cells, which are the gas flow compartments on the anode and cathode side of the cells respectively.

In particular, for an SOEC type high-temperature solid oxide electrolysis cell, the cathode compartment comprises steam and hydrogen, a product of the electrochemical reaction, whereas the anode compartment includes a draining gas, if present, and oxygen, another product of the electrochemical reaction. For an SOFC type high-temperature solid oxide fuel cell, the anode compartment comprises the fuel, whereas the cathode compartment comprises the oxidant.

To carry out high temperature steam electrolysis (HTE), steam (H₂O) is injected into the cathode compartment. Under the effect of the electric current applied to the cell, the dissociation of the water molecules in vapor form is carried out at the interface between the hydrogen electrode (cathode) and the electrolyte: this dissociation produces dihydrogen gas (H₂) and oxygen ions (O²⁻). The dihydrogen (H₂) is collected and discharged at the hydrogen compartment outlet. The oxygen ions (O²⁻) migrate through the electrolyte and recombine into dioxygen (O₂) at the interface between the electrolyte and the oxygen electrode (anode). A draining gas, such as air, can flow at the anode and thus collect the oxygen generated in gaseous form at the anode.

To ensure the operation of a solid oxide fuel cell (SOFC), air (oxygen) is injected into the cathode compartment of the fuel cell and hydrogen is injected into the anode compartment. Oxygen from the air will dissociate into O²⁻ ions. These ions will migrate in the electrolyte from the cathode to the anode to oxidize hydrogen and form water with simultaneous electricity generation. In an SOFC fuel cell, as in SOEC electrolysis, steam is found in the dihydrogen (H₂) compartment. Only the polarity is inverted.

By way of illustration, FIG. 1 represents a schematic view showing the operating principle of an SOEC type high-temperature solid oxide electrolysis cell. The function of such an electrolysis cell is to convert steam into hydrogen and oxygen according to the following electrochemical reaction:

2 H₂O→2 H₂+O₂.

This reaction is carried out electrochemically in the cells of the electrolysis cell. As shown schematically in FIG. 1, each unit electrolysis cell 1 is formed of a cathode 2 and an anode 4, placed on either side of a solid electrolyte 3. The two electrodes (cathode and anode) 2 and 4 are electron and/or ion conductors, made of porous material, and the electrolyte 3 is impervious to gas, an electron insulator and ion conductor. The electrolyte 3 can in particular be an anion conductor, more specifically an O²⁻ ion anion conductor, and the electrolysis cell is then referred to as an anion electrolyzer, as opposed to proton (H⁺) electrolytes.

The electrochemical reactions take place at the interface between each of the electron conductors and the ion conductor.

At the cathode 2, the half-reaction is as follows:

2 H₂O+4 e⁻→2 H₂+2 O²⁻.

At the anode 4, the half-reaction is as follows:

2 O²⁻→O₂+4 e⁻.

The electrolyte 3, interposed between the two electrodes 2 and 4, is the location of O²⁻ ion migration under the effect of the electric field created by the potential difference applied between the anode 4 and the cathode 2.

As illustrated between brackets in FIG. 1, the steam at the cathode inlet can be accompanied by hydrogen H₂and the hydrogen produced and recovered at the outlet can be accompanied by steam. Similarly, as illustrated by dotted lines, a draining gas, such as air, can furthermore be injected at the inlet on the anode side to discharge the oxygen produced. Injecting a draining gas has the additional function of acting as a thermal regulator.

A unit electrolysis cell, or electrolysis reactor, consists of a unit cell as described above, with a cathode 2, an electrolyte 3, and an anode 4, and two interconnectors which fulfill the functions of electrical and fluidic distribution.

To increase the hydrogen and oxygen flow rates produced, it is known to stack several unit electrolysis cells on top of one another by separating them with interconnectors. The assembly is positioned between two end interconnection plates which support the electrical power supplies and the gas supplies of the electrolysis cell (electrolytic reactor). An SOEC type high-temperature solid oxide electrolysis cell thus comprises at least one, generally a plurality of electrolysis cells stacked on top of one another, each unit cell being formed of an electrolyte, a cathode and an anode, the electrolyte being interposed between the anode and the cathode.

As stated above, the fluidic and electrical interconnection devices which are in electrical contact with one or more electrodes generally fulfill the functions of supplying and collecting electric current and delimit one or more gas flow compartments.

Thus, the function of said cathode compartment is that of distributing electric current and steam and also that of recovering hydrogen at the cathode in contact.

The function of said anode compartment is that of distributing electric current and also of recovering the oxygen produced at the anode in contact, optionally using a draining gas. FIG. 2 shows an exploded view of unit cells of an SOEC type high-temperature solid oxide electrolysis cell according to the prior art. This electrolysis comprises a plurality of unit solid oxide electrolysis (SOEC) type cells C1, C2, alternately stacked with interconnectors 5. Each cell C1, C2 consists of a cathode 2.1, 2.2 and an anode (only the anode 4.2 of the cell C2 is shown), between which an electrolyte is disposed (only the electrolyte 3.2 of the cell C2 is shown).

The interconnector 5 is typically a metal alloy component which ensures the separation between the cathode 50 and anode 51 compartments, defined by the volumes between the interconnector 5 and the adjacent cathode 2.1 and between the interconnector 5 and the adjacent anode 4.2 respectively. It also ensures gas distribution to the cells. Steam is injected into each unit cell in the cathode compartment 50. The hydrogen produced and the residual steam at the cathode 2.1, 2.2 is collected in the cathode compartment 50 downstream of the cell C1, C2 after dissociation of steam by the latter. The oxygen produced at the anode 4.2 is collected in the anode compartment 51 downstream of the cell C1, C2 after dissociation of steam by the latter. The interconnector 5 ensures the flow of current between the cells C1 and C2 by direct contact with the adjacent electrodes, i.e. between the anode 4.2 and the cathode 2.1.

In current stack structures (a stack being a sandwich formed by the interconnectors and electrochemical cells placed between two rigid terminal plates, electrically insulated from the interconnectors), the dual function of the interconnectors of gas distribution and of supplying the electric current to the cells is fulfilled by contact layers, which are conductive metallic and/or ceramic structures, in particular, strontium-doped lanthanum manganite (LSM) ceramic structures, or metal grids.

By way of example, French patent application FR 2 996 065 A1 describes an interconnector in the form of a metal alloy substrate component, the base element of which is iron (Fe) or nickel (Ni), with one of the main planar faces coated with a thick metal or ceramic contact layer, grooved by delimiting channels adapted for the distribution and/or collection of gases, such as steam H₂O, H₂; O₂, draining gas. In particular, a thick contact layer (the thickness of which is greater than that of a layer obtained with so-called “thin layer” technology, typically a thickness between 2 and 15 μm) of ceramic based on strontium-doped lanthanum manganite (LSM) can be provided on the side of the oxygen electrode (anode in HTE, cathode for an SOFC fuel cell).

The development of industrial systems incorporating high-temperature solid oxide electrolysis cells (SOECs) and solid oxide fuel cells (SOFCs) involves an increase in the treated gas volume. For this purpose, increasing the surface area, the number of cells and interconnection plates per stack is necessary. The voltage and current levels applied must also be adjusted with the increase in the number of plates. Due to its structure having large surface areas subject to pressure, the level of pressurization of the high-temperature stacks remains limited. It becomes necessary to optimize the structure of the hydraulic networks to limit head losses. This optimization particularly involves reducing singular head losses within the stack. The transition zones located at the supply inlets and outlets of the anode and cathode chambers are zones where optimization of the geometries allows substantial gains in head loss.

In order to increase production efficiency and obtain a good operating homogeneity of SOEC/SOFC type solid oxide cell stacks operating at high temperature, the role of interconnectors is essential, in particular for obtaining good electrical contacts between the different portions of the stacks and also for allowing good gas distribution within the electrochemical cells. The interconnectors can be metallic and composed of three thin plates, as described in French patent application FR 3 024 985 A1.

FIG. 3 thus represents, in an exploded view, an example of an interconnector 5 according to the prior art formed by the assembly of three assembled and laminated thin metal sheets 21 to 23.

The three sheets 21, 22, 23 are elongated along two axes of symmetry X and Y orthogonal to each other, the sheets being laminated and assembled together by welding. A central sheet 22 is inserted between a first end sheet 21 and a second end sheet 23.

The central sheet 22 comprises a pressed central portion 70 defining relief, or pressed, elements 10, and is perforated at the periphery of its central portion 70, with four slots 71, 72, 73, 74. “Slot” means a hole through either side of a metal sheet.

One of the planar end sheets 21 comprises a planar central portion 69 and is perforated, at the periphery of its central portion 69, with four slots 61, 62, 63, 64. The first end sheet 21 further comprises two slits 67, 68, slots arranged symmetrically on either side of the Y axis. They are elongated along a length corresponding substantially to the length of the central portion 69 along the Y axis.

The other of the planar end sheets 23 comprises a recessed central portion 89 perforated, at the periphery of its central portion 89, with four slots 81, 82, 83, 84.

The slots 61, 71, 81, 63, 73, 83 of each sheet are elongated along a length corresponding substantially to the length of the central portion 69, 70, 89 along the axis X, whereas the slots 62, 72, 82, 64, 74, 84 of each sheet are elongated along a length corresponding substantially to the length of the central portion 69, 70, 89 along the axis Y.

The slots 71 to 74 of the central sheet 22 are respectively widened relative to the slots 61, 81, 62, 82, 63, 83, 64, 84, and they comprise, in their widened portion, sheet metal tabs 710, 720, 730, 740 spaced apart from one another while forming a comb. Each of the slits 711, defined between the edge of the widened slot 71 and a tab 710 or between two successive tabs 710 emerges at the channels 11 defined by the relief elements 10 or pressed elements. The same applies to the slits made on the side of the slots 72, 73, 74.

The sheets 21, 22, 23 are typically made of ferritic steel with in the order of 20% chromium, preferably made of CROFER® 22APU or FT 18TNb, based on Inconel® 600 or Haynes® type Nickel in thicknesses typically between 0.1 and 1 mm.

The choice to use metal grids for the contact layers, arranged on the interconnectors, is linked to a dual technical and economic compromise. This type of structure, which is very simple to manufacture and low-cost, makes it possible, while ensuring flow in its thickness, to distribute gases homogeneously and to provide a multitude of electrical contact points also distributed homogeneously throughout the cell. To enhance the fluidics by ensuring a sweep of the complete surface area of the cell and to ensure good current transfer throughout the surface area of the cell, the grids can be wider than the cell. On the edges of the grid, protruding from the cell, welding spots are generally produced to lock the latter in position on the interconnector. In this type of configuration, the grid covers the gas inlets/outlets leading to a reduction in the flow cross-section and an increase in the singular head loss in this zone. The size of the grid can be identical to the size of the cell to limit the bending thereof. However, in this configuration, some of the gas flows outside the usable zone and reduces the maximum utilization rate of the gases sent.

Furthermore, adding glass in the grid, as described in French patent application FR 3 056 337 A1, makes it possible to guide the gas flow used in the usable zone.

To limit head losses due to gas flow in the grid at the inlets and outlets, it is possible to reduce its size to the usable size of the cell, but cell bending problems arise. With a grid size of the size of the usable surface area, it is also difficult to guide the gas only in the usable zone. Indeed, tightness must be created between the edge of the grid and the cell, which is not easy.

Therefore, there are still needs to optimize the interconnectors, in particular from a fluidic and mechanical point of view, and in particular in order to reduce head losses arising during gas flow.

### DISCLOSURE OF THE INVENTION

The aim of the invention is to at least partly remedy the needs mentioned above and the drawbacks relating to the embodiments of the prior art.

It is particularly aimed at producing an optimized interconnector design for stacks of SOEC/SOFC type solid oxide cells, in particular by means of a contact layer geometry making it possible to improve gas flow in the chambers supplying the cells, by clearing the zone located at the supply channel inlets/outlets on the interconnectors.

Thus, the subject matter of the invention is, according to one of its aspects, an interconnector for a stack of SOEC/SOFC type solid oxide cells operating at high temperature, intended to be arranged between two adjacent electrochemical cells of the stack, each electrochemical cell being formed of a cathode, an anode and an electrolyte interposed between the cathode and the anode, the interconnector being formed by assembling at least three elongated plates in a first axis of symmetry and a second axis of symmetry orthogonal to each other, a central plate being interposed between a first end plate and a second end plate, the central plate comprising a central portion and, at its periphery, at least two elongated slots along a length corresponding substantially to the length of the central portion in the first axis of symmetry and two elongated slots along a length corresponding substantially to the length of the central portion in the second axis of symmetry, each slot comprising tabs spaced apart from one another to form a comb and slits defined between the edge of a slot and a tab or between two successive tabs,
characterized in that at least one of the first end plate and the second end plate is covered in the central portion with a contact layer with an electrochemical cell, the surface area of which is greater than that of the central portion of the central plate, and particularly that of an electrochemical cell, the contact layer comprising at least one elongated contact slot along a length greater than the length of the central portion in the first axis of symmetry and/or the second axis of symmetry and formed at least partially in superposition with at least one slot of the central plate comprising tabs.

The interconnector according to the invention may further comprise one or more of the following features taken individually or according to all possible technical combinations.

Said at least one contact slot of the contact layer can be obtained by different cutting methods, and particularly be cut with a laser.

Furthermore, said contact layer can be a thick, optionally porous, ceramic coating layer, the ceramic material being in particular chosen from lanthanum manganite of formula La₁₋ₓSrₓMO₃ where M (transition metals)=Nickel (Ni), Iron (Fe), Cobalt (Co), Manganese (Mn), Chromium (Cr), alone or in a mixture, or lamellar structure materials such as lanthanide nickelates of formula Ln₂NiO₄ (Ln=Lanthanum (La), Neodymium (Nd), Praseodymium (Pr)), or another electrically conductive perovskite oxide.

Alternatively, said contact layer can be a thick metal coating layer, the metal material being particularly chosen from Nickel (Ni) and its alloys or chromia-forming alloys, the base element of which is Iron (Fe).

Moreover, the width of said at least one contact slot can be greater than the width of the channel formed by the visible portion through said at least one contact slot of the tabs of said at least one slot.

Furthermore, the difference between the width of said at least one contact slot and the width of the channel formed by the visible portion through said at least one contact slot of the tabs of said at least one slot can be greater than or equal to 2.5 mm.

A portion of said at least one of the first end plate and the second end plate and a portion of the tabs of said at least one slot of the central plate can be visible through said at least one contact slot.

Furthermore, the difference between the length of said at least one contact slot and the length of the central portion of the central plate can be greater than or equal to 2.5 mm.

The distance between an edge of said at least one contact layer and said at least one contact slot can be greater than or equal to 5 mm.

Moreover, the ratio of the surface area of said at least one contact layer relative to the surface area of said central portion of the central plate, particularly of an electrochemical cell, can be greater than or equal to 75%.

Moreover, the invention furthermore relates, according to another of its aspects, to a stack of SOEC/SOFC type solid oxide cells operating at high temperature, comprising a plurality of electrochemical cells each formed of a cathode, an anode and an electrolyte interposed between the cathode and the anode, and a plurality of interconnectors as defined above, each arranged between two adjacent electrochemical cells.

### BRIEF DESCRIPTION OF THE DRAWINGS

The invention may be better understood by reading the following detailed description, non-exhaustive examples of implementation thereof, and by examining the schematic and partial figures of the appended drawing, on which:

FIG. 1 is a schematic view showing the operating principle of a high-temperature solid oxide electrolysis cell (SOEC),

FIG. 2 is a schematic exploded view of a portion of a high-temperature solid oxide electrolysis cell (SOEC) comprising interconnectors according to the prior art,

FIG. 3 is an exploded view of an interconnector for a stack of SOEC/SOFC type high-temperature solid oxide cells, corresponding to the assembly of three thin sheets or plates,

FIG. 4 is a partial top perspective view of an example of an interconnector according to the invention, consisting of three thin sheets or plates, the central sheet comprising tabs,

FIG. 5 is a partial top view of the interconnector of FIG. 4, the second upper end plate being transparent,

FIG. 6 is a detailed top perspective view of the interconnector of FIG. 4 showing the gas flow through a slot of the contact layer,

FIG. 7 is another detailed top view, showing the geometry of a slot of the contact layer, and

FIG. 8 represents, in a top perspective view, an assembly comprising a stack of SOEC/SOFC type solid oxide cells with interconnectors according to the invention and a system for clamping the stack.

In all of these figures, identical references may designate identical or similar elements.

Furthermore, the individual parts shown in the figures are not necessarily shown according to a uniform scale, to make the figures more readable.

### DETAILED DISCLOSURE OF SPECIFIC EMBODIMENTS

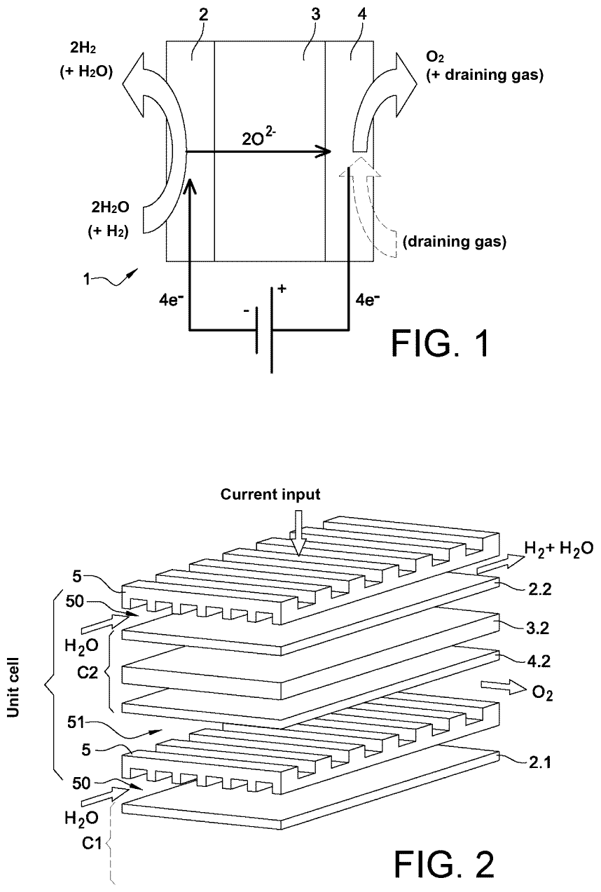

FIGS. 1 to 3 have already been described above in the part relating to the prior art and the technical context of the invention. It is specified that, for FIGS. 1 and 2, the symbols and arrows for supplying steam H₂O, distributing and recovering dihydrogen H₂, oxygen O₂, air and electric current are shown for clarity and accuracy, to illustrate the function of the devices shown.

Furthermore, it should be noted that all the constituents (anode/electrolyte/cathode) of a given electrochemical cell are preferably ceramic. The operating temperature of a high-temperature SOEC/SOFC type stack is moreover typically between 600 and 1000 °C.

Furthermore, the optional terms “upper” and “lower” are to be understood here according to the normal orientation direction of an SOEC/SOFC type stack when in its configuration of use.

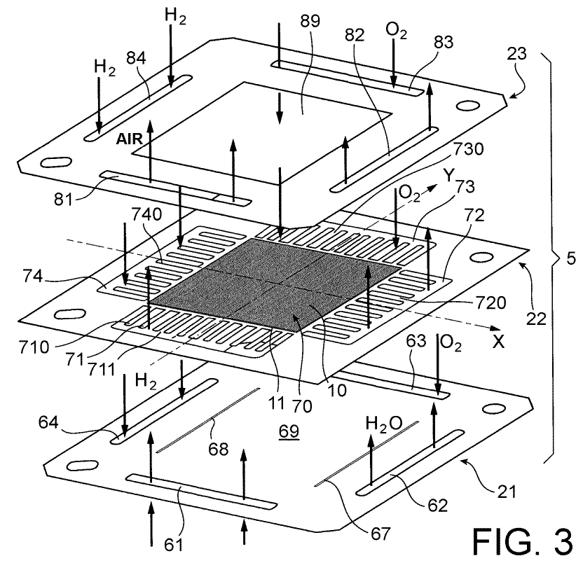

An interconnector 5 according to the prior art has already been described above with reference to FIG. 3. Identical elements will not be described again but remain within the scope of the invention.

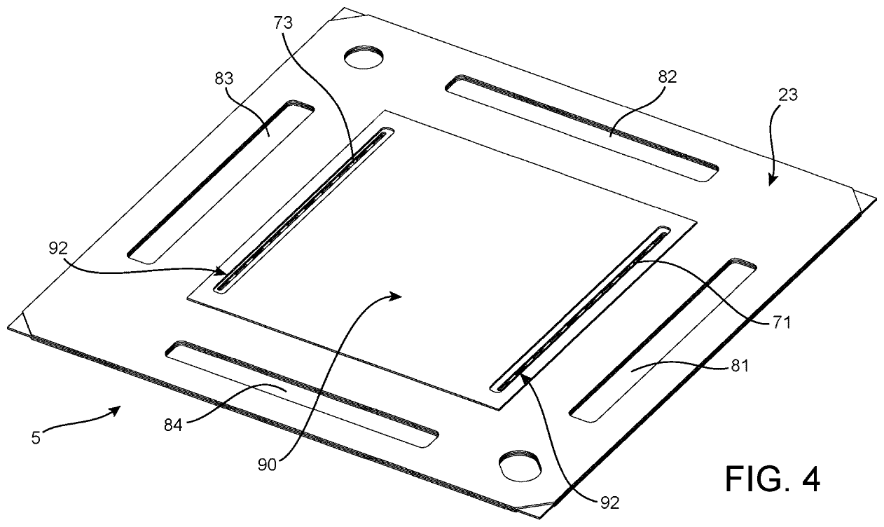

FIGS. 4 to 7 partially illustrate an example of an interconnector according to the invention, comprising the three sheets 21, 22 and 23.

In this example, in a non-limiting manner, the second end plate 23 is covered in the central part with a contact layer 90 intended to be interposed between the interconnector 5 and an electrochemical cell 1.

This contact layer 90 is for example a Nickel grid in the hydrogen chamber.

The surface area of the contact layer 90 is greater than that of the central portion 70 of the central plate 22, and than that of an electrochemical cell 1.

Advantageously, the contact layer 90 comprises two slots 92, opposite one another on either side of the central portion, elongated along a length L_{c} greater than the length Lₚ of the central portion 70 in the first axis of symmetry X and formed in partial superposition respectively with the slots 71 and 73 of the central plate 22 comprising the tabs 710 and 730 respectively.

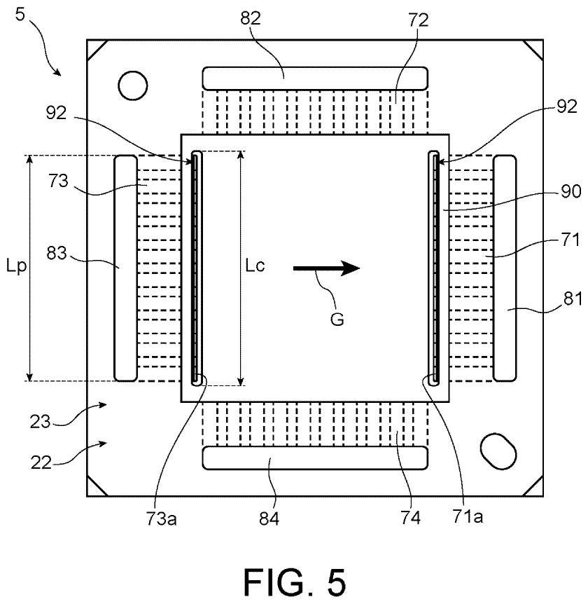

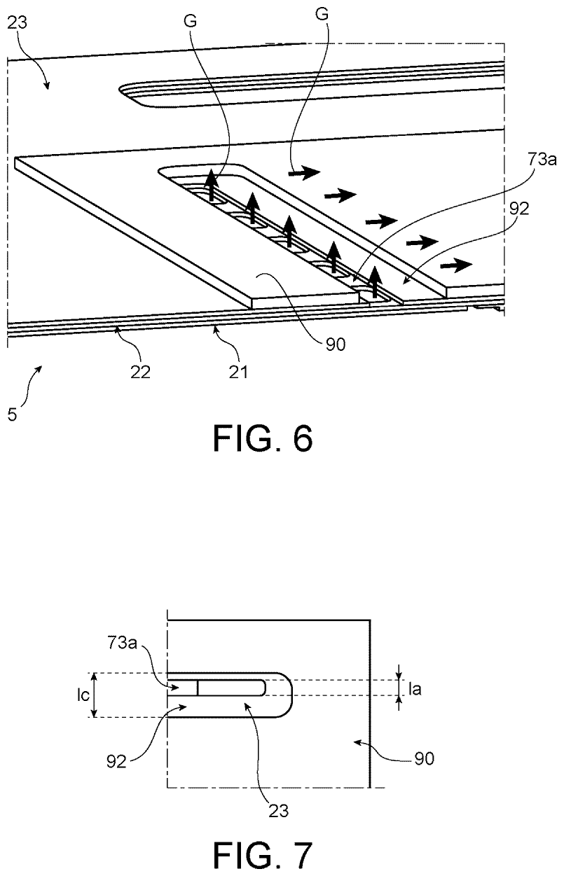

In this contact layer 90, or contact grid, it is possible to deposit a glass layer in order to ensure good gas distribution and to maximize fuel utilization rates, as described in French patent application FR 3 056 337 A1. The benefit of adding glass described in this application and significantly reduction in singular head losses at the manifold outlet are thus obtained. Indeed, the slots 92 formed in the contact layer 90 form openings at the supply inlets/outlets positioned under the contact layer 90 making it possible to clear the gas flow and thus limit the singular head losses created. It should be noted that in FIGS. 5 and 6, the arrows G represent the direction of gas flow.

Advantageously, but not in a limited manner, the slots 92 are laser cuts making it possible to clear the gas flow. Laser cutting makes it possible to be precise and not induce fiber deformation and excessive thicknesses. These cuts prevent the presence of threads above the gas supply channels and thus make it possible to increase the flow cross-section. It should be noted that for a standard non-perforated contact layer, this restriction on the equivalent hydraulic diameter can represent up to 50% of the cross-section (according to the thread diameter, mesh and channel geometry).

Advantageously, the slots 92 in cut form are produced without modifying the external dimensions of the contact layer 90, thus making it possible to ensure electrical contact on the entire surface area of the cell with a sufficient lateral projection of the contact layer 90 sufficient to allow tack welding thereof, and optional lateral glass deposition as described in French patent application FR 3 056 337 A1.

It should also be noted that the constraints linked to the slots 92 in cut form are directly linked to the technical parameters of the contact layer 90, particularly thread diameter and mesh parameters, and to the geometry of the channels of the interconnectors 5. If laser cutting of the contours of the contact layer 90 and the slots 92 does not technically pose any difficulties, in order to ensure good mechanical strength of the contact layer 90 by preventing risks of drawing of the fibers at the ends thereof, a minimum distance between the outer edge and the cutting zone is particularly between 5 and 10 times the mesh width. This minimum distance makes it possible to have a sufficient surface area for tack welding the contact layer 90 on the interconnector 5.

Moreover, to ensure good clearance of the contact layer 90 relative to the channels, the cutting width must slightly exceed the width of the channels. Thus, as seen in FIG. 7, the width Ic of each contact slot 92 is greater than the width la of the channel 71a, 73a formed by the visible portion through each contact slot 92 of the tabs 710, 730 of the slots 71 and 73.

In particular, the difference between the width Ic of each contact slot 92 and the width la of each channel 71a, 73 a is greater than or equal to 2.5 mm.

Furthermore, the difference between the length L_{c} of each contact slot 92 and the length Lₚ of the central portion 70 of the central plate 22 is greater than or equal to 2.5 mm, and the distance between an edge of the contact layer 90 and a contact slot 92 is greater than or equal to 5 mm.

Furthermore, the ratio of the surface area of the contact layer 90 relative to the surface area of the central portion 70 of the central plate 22, particularly of an electrochemical cell 1, is greater than or equal to 75%. In particular, for a 100 cm² cell, the contact layer 90 will be 144 cm².

It should be noted that relative to a contact layer of the prior art of which the dimensions would be smaller, not covering the channels, the perforated contact layer 90 according to the invention makes it possible, without obstructing the gas supplies, to have an optimal bearing surface area for transferring the compression forces applied to the stack, required for current transfer, and also makes it possible to increase the fuel utilization rate according to French patent application FR 3 056 337 A1. As the cell is sandwiched between the contact layer 90 on one side and an LSM channel network on the other, with a seal deposited on its periphery, a contact layer 90 ensuring external bearing at the mechanical contact zone of the cell limits stresses on the latter.

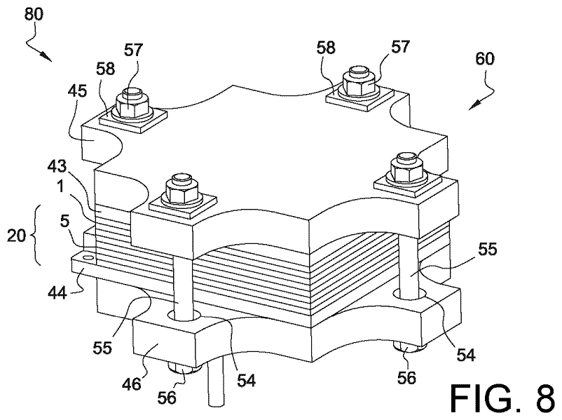

Furthermore, FIG. 8 represents a stack 20 of SOEC/SOFC type solid oxide cells operating at high temperature according to the invention.

More specifically, FIG. 8 shows an assembly 80 comprising the stack 20 of SOEC/SOFC type solid oxide cells and a clamping system 60.

This assembly 80 has a similar structure to that of the assembly described in French patent application FR 3 045 215 A1.

The stack 20 comprises a plurality of electrochemical cells 1 each formed by a cathode, an anode and an electrolyte interposed between the cathode and the anode, and a plurality of interconnectors 5 according to the invention each arranged between two adjacent electrochemical cells 1. This assembly of electrochemical cells 1 and interconnectors 5 can also be referred to as “stack”.

Furthermore, the stack 20 comprises an upper end plate 43 and a lower end plate 44, respectively also referred to as upper stack end plate 43 and lower stack end plate 44, between which the plurality of electrochemical cells 1 and the plurality of interconnectors 5 are clamped, i.e. between which the stack is located.

Moreover, the assembly 80 also comprises a system 60 for clamping the stack 20 of SOEC/SOFC type solid oxide cells, comprising an upper clamping plate 45 and a lower clamping plate 46, between which the stack 20 of SOEC/SOFC type solid oxide cells is clamped.

Each clamping plate 45, 46 of the clamping system 60 comprises four clamping orifices 54. Furthermore, the clamping system 60 further comprises four clamping rods 55, or tie rods, extending through a clamping orifice 54 of the upper clamping plate 45 and through a corresponding clamping orifice 54 of the lower clamping plate 46 to make it possible to assemble the upper 45 and lower 46 clamping plates together. The clamping system 60 further comprises clamping means 56, 57, 58 at each clamping orifice 54 of the upper 45 and lower 46 clamping plates cooperating with the clamping rods 55 to make it possible to assemble the upper 45 and lower 46 clamping plates together. More specifically, the clamping means comprise, at each clamping orifice 54 of the upper clamping plate 45, a first clamping nut 56 cooperating with the corresponding clamping rod 55 inserted through the clamping orifice 54. Furthermore, the clamping means comprise, at each clamping orifice 54 of the lower clamping plate 46, a second clamping nut 57 associated with a clamping washer 58, which cooperate with the corresponding clamping rod 55 inserted through the clamping orifice 54. The clamping washer 58 is located between the second clamping nut 57 and the lower clamping plate 46.

Of course, the invention is not limited to the example embodiments that have just been described. Various modifications may be made thereto by the person skilled in the art.

1. An interconnector for a stack of SOEC/SOFC type solid oxide cells operating at high temperature, intended to be arranged between two adjacent electrochemical cells of the stack, each electrochemical cell being formed of a cathode, an anode and an electrolyte interposed between the cathode and the anode, the interconnector being formed by assembling at least three elongated plates in a first axis of symmetry and a second axis of symmetry orthogonal to each other, a central plate being interposed between a first end plate and a second end plate, the central plate comprising a central portion and, at its periphery, at least two elongated slots along a length corresponding substantially to the length of the central portion in the first axis of symmetry and two elongated slots along a length corresponding substantially to the length of the central portion in the second axis of symmetry, each slot comprising tabs spaced apart from one another to form a comb and slits defined between the edge of a slot and a tab or between two successive tabs,
wherein at least one of the first end plate and the second end plate is covered, at a central portion, with a contact layer with an electrochemical cell, the surface area of which is greater than that of the central portion of the central plate, and particularly of an electrochemical cell, the contact layer comprising at least one elongated contact slot along a length greater than the length of the central portion in the first axis of symmetry and/or the second axis of symmetry and formed at least partially in superposition with at least one slot of the central plate comprising tabs.

2. The interconnector according to claim 1, wherein said at least one contact slot of the contact layer is cut with a laser.

3. The interconnector according to claim 1, wherein said contact layer is a thick, optionally porous, ceramic coating layer, the ceramic material being in particular chosen from lanthanum manganite of formula La₁₋ₓSrₓMO₃ where M (transition metals)=Nickel (Ni), Iron (Fe), Cobalt (Co), Manganese (Mn), Chromium (Cr), alone or in a mixture, or lamellar structure materials such as lanthanide nickelates of formula Ln₂NiO₄ (Ln=Lanthanum (La), Neodymium (Nd), Praseodymium (Pr)), or another electrically conductive perovskite oxide.

4. The interconnector according to claim 1, wherein said contact layer is a thick metal coating layer, the metal material being particularly chosen from Nickel and its alloys or chromia-forming alloys, the base element of which is Iron.

5. The interconnector according to claim 1, wherein the width of said at least one contact slot is greater than the width of the channel formed by the visible portion through said at least one contact slot of the tabs of said at least one slot.

6. The interconnector according to claim 1, wherein the difference between the width of said at least one contact slot and the width of the portion of the channel which is visible through said at least one contact slot of the tabs of said at least one slot is greater than or equal to 2.5 mm.

7. The interconnector according to claim 1, wherein a portion of said at least one of the first end plate and the second end plate and a portion of the tabs of said at least one slot of the central plate are visible through said at least one contact slot.

8. The interconnector according to claim 1, wherein the difference between the length of said at least one contact slot and the length of the central portion of the central plate is greater than or equal to 2.5 mm.

9. The interconnector according to claim 1, wherein the distance between an edge of said at least one contact layer and said at least one contact slot is greater than or equal to 5 mm.

10. The interconnector according to claim 1, wherein the ratio of the surface area of said at least one contact layer relative to the surface area of said central portion of the central plate, particularly of an electrochemical cell, is greater than or equal to 75%.

11. A stack of SOEC/SOFC type solid oxide cells operating at high temperature, comprising a plurality of electrochemical cells each formed of a cathode, an anode and an electrolyte interposed between the cathode and the anode, and a plurality of interconnectors according to claim 1, each arranged between two adjacent electrochemical cells.
